(19) United States
(12) Patent Application Publication
(10) Pub. No.: US 2010/0222938 A1
(43) Pub. Date: Sep. 2, 2010

(54) WIRELESS FOOD TEMPERATURE DETECTING DEVICE

(75) Inventor: Mingfeng WENG, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/715,669

(22) Filed: Mar. 2, 2010

(30) Foreign Application Priority Data
Mar. 2, 2009 (CN) 200920136954.X

(51) Int. Cl. G05D 23/19

(52) U.S. Cl. 700/300

(57) ABSTRACT

The present invention relates to a grilling device, especially relates to a wireless food temperature detecting device, comprising: a temperature detecting unit, a controlling unit disposed on the processor of grilling device; said temperature detecting unit has a temperature detecting stick for inserting into the food which is prepared to be fried or roasted, and has a wireless emitting element electrically connected to said temperature detecting stick; said controlling unit has a wireless receiving element; said temperature detecting unit is controlling by signals transmitted between said wireless emitting element and said wireless receiving element. Compared to the conventional technique, the present invention controls the doneness of food by detecting the inner temperature of food. It is greatly convenient for the consumers to operate.

### FIELD OF THE INVENTION

The present invention relates to a grilling device, especially to a wireless food temperature detecting device adapted in grilling device.

### BACKGROUND OF THE INVENTION

When processing food with the conventional grilling device, the cook has to judge the doneness of food only by his experience, for example as cooking the meet, the medium rare beef\ medium beef\ medium well beef\ well done beef, medium well pork\ well done pork, medium veal\ medium well veal\ well done veal, well done chicken, and so on, it needs to be judged by the cook's experience, so it would be difficult for a freshman even for an experienced cook to determine whether the food is done, moreover, the cook must pay close attention to the cooking process, so he can not do other things at the same time, thereby the work efficiency is low.

### SUMMARY OF THE INVENTION

The objective of the present invention is to overcome the drawback of the conventional grilling device wherein the cook has to rely greatly on his experience to judge the doneness of food, it provides a wireless food temperature detecting device for automatically judging the doneness of the food.

The technical solution applied by the present invention is: a wireless food temperature detecting device, it comprises a temperature detecting unit, a controlling unit disposed on the processor of grilling device; wherein said temperature detecting unit has a temperature detecting stick for inserting into the food which is prepared to be fried or roasted, and has a wireless emitting element electrically connected to said temperature detecting stick; said controlling unit has a wireless receiving element; said temperature detecting unit is controlling by signals transmitted between said wireless emitting element and said wireless receiving element.

According to a preferred embodiment of the present invention, said wireless emitting element is an infrared emitting element and said wireless receiving element is an infrared receiving element.

According to a preferred embodiment of the present invention, said controlling unit comprises a controlling plate, which is electrically connected to a display panel, a knob assembly and said wireless receiving element.

According to a preferred embodiment of the present invention, it further comprises an storage box for storing said temperature detecting unit, which is movable disposed on the processor of said grilling device.

According to a preferred embodiment of the present invention, said storage box for storing temperature detecting unit is disposed on the processor of grilling device near said controlling unit.

According to a preferred embodiment of the present invention, said wireless emitting element is a frequency-modulated wireless emitting element, a blue-tooth wireless emitting element and said wireless receiving element is a frequency-modulated wireless emitting element, a blue-tooth wireless emitting element correspondingly.

According to a preferred embodiment of the present invention, said temperature detecting stick is a thermal resistor, thermal diode or thermocouple.

The present invention utilizes the principle of wireless emitting and receiving during the cooking process, the temperature detecting stick of temperature detecting unit is movable inserted into the food, the temperature detecting unit transmits temperature signal to the controlling unit on the processor of grilling device with the wireless emitting element disposed on said temperature detecting unit by wireless transmitting. So the user can observe the cooking process at any time, when the doneness of food meets the requirement, the controlling unit will alarm the user, thereby it is greatly convenient for the user to do other things during the cooking process.

Otherwise, it can input predetermined doneness and temperature of the generally cooked meat in the computer program, for example as the reference temperature of medium rare beef\ medium beef\ medium well beef\ well done beef, medium well pork\ well done pork, medium veal\ medium well veal\ well done veal, well done chicken, and so on; the user can respectively select the different doneness of meat according to a menu set by computer program in order to cook different meat.

Concluded from the description of the present invention, compared to the conventional technique, the wireless food temperature detecting device controls the doneness of food by detecting the inner temperature of food, whether a professional cook or a freshman, he can freely choose grilling style according to their requirements, it will be greatly convenient for the consumer to operate, and widely suitable for various kinds of grilling devices to process different kinds of food, especially suitable for frying and roasting meat.

### BRIEF DESCRIPTION OF THE DRAWINGS

FIG. 1 shows the first perspective structural view of the wireless food temperature detecting device applied in grilling device of a preferred embodiment of the present invention.

FIG. 2 shows the second perspective structural view of the wireless food temperature detecting device applied in grilling device of a preferred embodiment of the present invention.

FIG. 3 shows the electrical block diagram of the wireless food temperature detecting device applied in grilling device of a preferred embodiment of the present invention.

### DETAILED DESCRIPTION OF THE EMBODIMENTS

The present invention will become apparent by the reference of the following description of the embodiments.

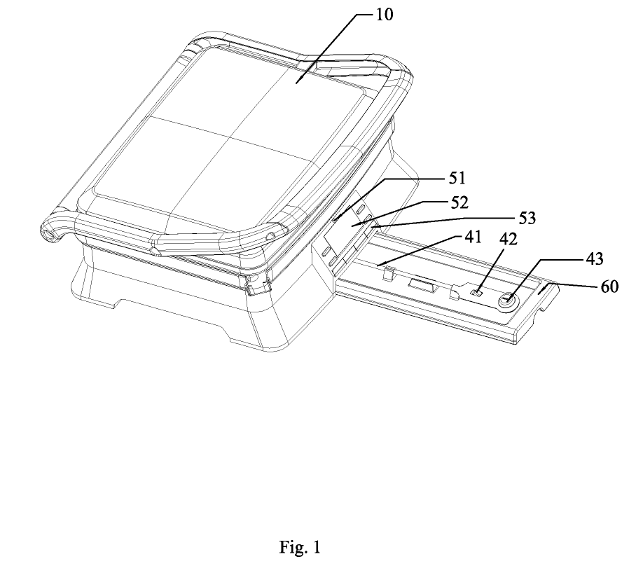

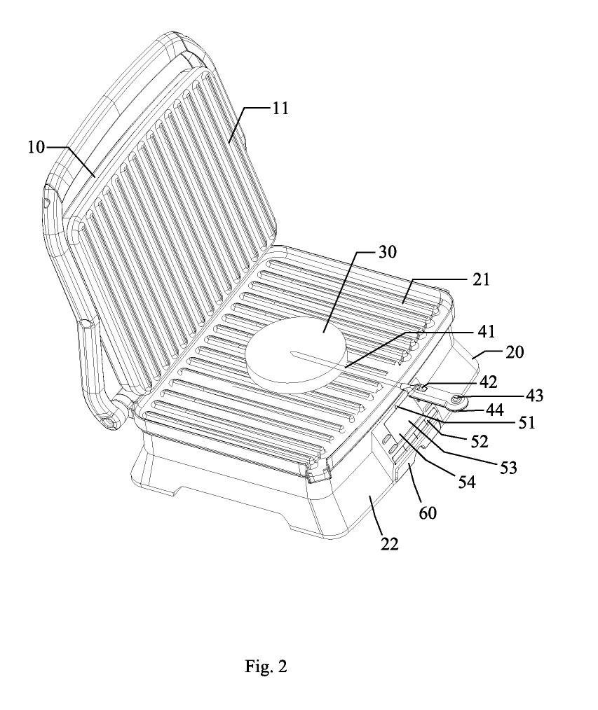

Please refer to FIG. 1 and FIG. 2, which shows the perspective structural view of the wireless food temperature detecting device applied in grilling device, said grilling device comprises an upper housing 10 and a lower housing 20 which are covered together, there are an upper roasting plate 11 and a lower roasting plate 21 respectively disposed on the upper housing 10 and lower housing 20. The wireless food temperature detecting device comprises a temperature detecting unit and controlling unit. Said controlling unit comprises a controlling substrate 54, said controlling substrate 54 is disposed on a side surface 22 of lower housing 20, said controlling substrate 54 is electrically connected to a display panel 53\ a knob assembly 52 and an infrared receiving element 51. The temperature detecting unit comprises a temperature detecting stick 41 for inserting into the food 31 which is prepared to be fried or roasted and an infrared emitting element 44 electrically connected to said temperature detecting stick 41, said temperature detecting unit further disposed has a temperature detecting switch 42 and battery 43.

The lower position of controlling unit on the side surface 22 of lower housing 20 is disposed with an extendable accommodation box 60 for accommodating temperature detecting unit, please refer to FIG. 1, which is the structural view of the accommodation box 60 when it extends; please refer to FIG. 2, which is the structural view of the accommodation box 60 when it draws back. The present invention provides an accommodation box 60 for conveniently accommodating temperature detecting unit, the temperature detecting unit can be directly took out from the accommodation box when it is needed to be used, and be accommodated in the accommodation box after using, it is convenient for both taking out and accommodating.

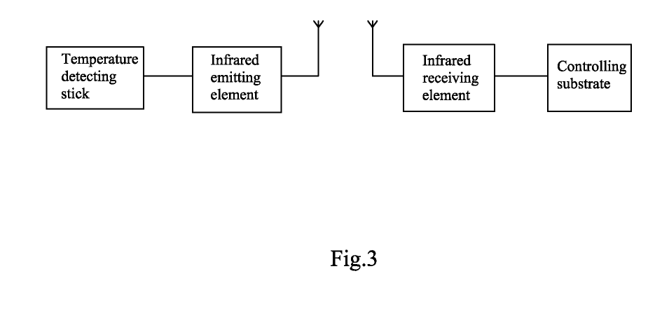

Please refer to FIG. 3, which is the electrical block diagram of a wireless food temperature detecting device of the present invention.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What the claim is:

1. A wireless food temperature detecting device, characterizes in that it comprises a temperature detecting unit, a controlling unit disposed on the processor of grilling device; wherein said temperature detecting unit has a temperature detecting stick for inserting into the food which is prepared to be fried or roasted, and has a wireless emitting element electrically connected to said temperature detecting stick; said controlling unit has a wireless receiving element; said temperature detecting unit is controlling by signals transmitted between said wireless emitting element and said wireless receiving element.

2. The wireless food temperature detecting device according to claim 1, characterizes in that said wireless emitting element is an infrared emitting element and said wireless receiving element is an infrared receiving element.

3. The wireless food temperature detecting device according to claim 1, characterizes in that said controlling unit comprises a controlling plate, which is electrically connected to a display panel, a knob assembly and said wireless receiving element.

4. The wireless food temperature detecting device according to claim 1, characterizes in that it further comprises an storage box for storing said temperature detecting unit, which is movable disposed on the processor of said grilling device.

5. The wireless food temperature detecting device according to claim 4, characterizes in that said storage box for storing temperature detecting unit is disposed on the processor of grilling device near said controlling unit.

6. The wireless food temperature detecting device according to claim 1, characterizes in that said wireless emitting element is a frequency-modulated wireless emitting element, a blue-tooth wireless emitting element and said wireless receiving element is a frequency-modulated wireless emitting element, a blue-tooth wireless emitting element correspondingly.

7. The wireless food temperature detecting device according to claim 1, characterizes in that said temperature detecting stick is a thermal resistor, thermal diode or thermocouple.
